(19) United States
(12) Patent Application Publication
(10) Pub. No.: US 2011/0286386 A1
(43) Pub. Date: Nov. 24, 2011

(54) Reliable Transfer of Time Stamped Multichannel Data Over A Lossy Mesh Network

(76) Inventors: Jeffrey J. Kellam, Austin, TX (US); Timothy H. Ousley, Austin, TX (US); Johann G. Scholtz, Austin, TX (US)

(21) Appl. No.: 12/782,799

(22) Filed: May 19, 2010

(51) Int. Cl. H04W 4/00

(52) U.S. Cl. 370/328

(57) ABSTRACT

System and method for transmitting data over a wireless medium. A wireless sensor node receives data from at least one sensor, where the data include a plurality of data sets. For each data set: the wireless sensor node compares the size of the data set with a specified packet size, and if the size of the data set exceeds the specified packet size, transmits a plurality of packets containing respective portions of the data set to a gateway device over a wireless medium. If the size of the data set does not exceed the specified packet size, then a packet containing the data set is transmitted to the gateway device over the wireless medium.

### FIELD OF THE INVENTION

The present invention relates to the field of wireless sensor systems, and more particularly to reliable transfer of time stamped multichannel data over a lossy wireless medium, e.g., a lossy mesh network.

### DESCRIPTION OF THE RELATED ART

Embedded measurement and control systems have been developed for a wide variety of applications, such as automated manufacturing and remote data collection, among others.

One common application for embedded systems is wireless sensor networks, where one or more wireless sensor nodes collect data and transmit the data to a gateway device, which may then transmit the data to a host controller, e.g., a computer, in a data packet.

Prior art wireless sensor nodes typically sample (measure) measurement data at discrete intervals and transfer the data to the gateway, where each data set (measurement) is sent in a respective packet. However, these nodes can only transfer small amount (e.g., less than 60 bytes) of measurement data per packet, and since each data set much fit in a single packet, large measurement data sets are not supported. Additionally, these prior art sensor nodes can only transfer a single sample before the next measurement data is sampled. Older samples that are not successfully transmitted are discarded when new measurement data is sampled.

Thus, improved systems and methods for transmitting data in wireless sensor systems are needed.

### SUMMARY OF THE INVENTION

Various embodiments of a system and method for performing reliable transfer of time stamped multichannel data over a lossy wireless medium, e.g., a lossy mesh network, are presented below.

First, a wireless sensor node may receive data from at least one sensor. In one embodiment, the received data may include a plurality of data sets. For example, in one exemplary application, the sensor node may be configured with a strain sensor for detecting strain, e.g., in a bridge or building infrastructure, where the strain sensor generates strain measurements, e.g., periodically, thereby generating multiple data sets over time. The strain measurements may include a waveform data type that is large enough to exceed the capacity of a single data packet. As indicated above, in some embodiments, the wireless sensor node may include multiple, possibly heterogeneous, sensors, e.g., strain, temperature, etc., and thus may generate data sets from measurements made by each sensor. Thus, the data may include a plurality of data sets, and may include data from multiple sensors, e.g., multi-channel data. Moreover, in some embodiments, the data may be time stamped. For example, each data set may include a time stamp indicating when the data were generated by the associated sensor, and/or when the data were received or acquired by the sensor node from the sensor.

The wireless sensor node may transmit the received (measurement) data to a gateway device. More specifically, the wireless sensor node may transmit multiple data sets to the gateway, processing each data set as described below.

Because there may be data sets that exceed the payload capacity of a packet, in order to transfer all of such a measurement data set from the sensor node to the gateway, the measurement data set may be subdivided into smaller sections and transferred using multiple data packets. Thus, for each data set, the sensor node may compare size of the data set with a specified packet size, i.e., with the size of a maximum payload for a packet.

If the size of the data set exceeds the specified packet size, then the sensor node may transmit a plurality of packets containing respective portions of the data set to a gateway device over a wireless medium, e.g., over a wireless network, point-to-point, etc. However, if it is determined that the size of the data set does not exceed the specified packet size, the sensor node may transmit a packet containing the data set to the gateway device over the wireless medium. Thus, the plurality of data sets may be packetized and transmitted to the gateway device in a more efficient manner than prior art approaches.

In some embodiments, the method may iterate, where the sensor node receives further data, e.g., additional pluralities of data sets from the at least one sensor, and performs the above-described method elements with respect to each plurality of data sets.

Thus, various embodiments of the techniques disclosed herein may facilitate reliable transfer of time stamped multichannel data across a lossy wireless medium, e.g., a lossy mesh network.

### BRIEF DESCRIPTION OF THE DRAWINGS

A better understanding of the present invention can be obtained when the following detailed description of the preferred embodiment is considered in conjunction with the following drawings, in which:

FIG. 1A illustrates an exemplary wireless sensor system, according to an embodiment of the present invention;

FIG. 1B illustrates an exemplary wireless sensor system, including a host computer, according to an embodiment of the present invention;

FIG. 2 illustrates an exemplary implementation of a wireless sensor system, including a host computer, according to an embodiment of the present invention;

FIG. 3 is an exemplary block diagram of the host computer systems of FIGS. 1B and 2;

FIG. 4A is an exemplary block diagram of a wires sensor with a processor and memory, according to one embodiment;

FIG. 4B is an exemplary block diagram of a wires sensor with a processor and memory, and a programmable hardware element, according to one embodiment;

FIG. 5 is a flowchart diagram illustrating one embodiment of a method for transfer of time-stamped multichannel data over a lossy wireless medium, e.g., a mesh network; and

FIG. 6 is a flowchart diagram illustrating another embodiment of a method for transfer of time-stamped multichannel data over a lossy wireless medium, e.g., a mesh network.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE INVENTION

### Incorporation by Reference

The following references are hereby incorporated by reference in their entirety as though fully and completely set forth herein:
U.S. Pat. No. 4,914,568 titled “Graphical System for Modeling a Process and Associated Method,” issued on Apr. 3, 1990.
U.S. Pat. No. 5,481,741 titled “Method and Apparatus for Providing Attribute Nodes in a Graphical Data Flow Environment”.
U.S. Pat. No. 6,173,438 titled “Embedded Graphical Programming System” filed Aug. 18, 1997.
U.S. patent application Ser. No. 09/745,023, titled “Modular Compact Sensor Interface,” filed Jun. 23, 2004.

### Terms

The following is a glossary of terms used in the present application:

Memory Medium—Any of various types of memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; or a non-volatile memory such as a magnetic media, e.g., a hard drive, or optical storage. The memory medium may comprise other types of memory as well, or combinations thereof. In addition, the memory medium may be located in a first computer in which the programs are executed, and/or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Functional Unit—may include a processor and memory or a programmable hardware element (possibly with memory). The term “functional unit” may include one or more processors and memories and/or one or more programmable hardware elements. As used herein, the term “processor” is intended to include any of types of processors, CPUs, microcontrollers, or other devices capable of executing software instructions.

Program—the term “program” is intended to have the full breadth of its ordinary meaning The term “program” includes 1) a software program which may be stored in a memory and is executable by a processor or 2) a hardware configuration program useable for configuring a programmable hardware element.

Software Program—the term “software program” is intended to have the full breadth of its ordinary meaning, and includes any type of program instructions, code, script and/or data, or combinations thereof, that may be stored in a memory medium and executed by a processor. Exemplary software programs include programs written in text-based programming languages, such as C, C++, PASCAL, FORTRAN, COBOL, JAVA, assembly language, etc.; graphical programs (programs written in graphical programming languages); assembly language programs; programs that have been compiled to machine language; scripts; and other types of executable software. A software program may comprise two or more software programs that interoperate in some manner. Note that various embodiments described herein may be implemented by a computer or software program. A software program may be stored as program instructions on a memory medium.

Hardware Configuration Program—a program, e.g., a netlist or bit file, that can be used to program or configure a programmable hardware element.

Graphical Program—A program comprising a plurality of interconnected nodes or icons, wherein the plurality of interconnected nodes or icons visually indicate functionality of the program. The interconnected nodes or icons are graphical source code for the program. Graphical function nodes may also be referred to as blocks.

The following provides examples of various aspects of graphical programs. The following examples and discussion are not intended to limit the above definition of graphical program, but rather provide examples of what the term “graphical program” encompasses:

The nodes in a graphical program may be connected in one or more of a data flow, control flow, and/or execution flow format. The nodes may also be connected in a “signal flow” format, which is a subset of data flow.

Exemplary graphical program development environments which may be used to create graphical programs include LabVIEW®, DasyLab™, DiaDem™ and Matrixx/SystemBuild™ from National Instruments, Simulink® from the MathWorks, VEE™ from Agilent, WiT™ from Coreco, Vision Program Manager™ from PPT Vision, SoftWIRE™ from Measurement Computing, Sanscript™ from Northwoods Software, Khoros™ from Khoral Research, SnapMaster™ from HEM Data, VisSim™ from Visual Solutions, ObjectBench™ by SES (Scientific and Engineering Software), and VisiDAQ™ from Advantech, among others.

The term “graphical program” includes models or block diagrams created in graphical modeling environments, wherein the model or block diagram comprises interconnected blocks (i.e., nodes) or icons that visually indicate operation of the model or block diagram; exemplary graphical modeling environments include Simulink®, SystemBuild™, VisSim™, Hypersignal Block Diagram™, etc.

A graphical program may be represented in the memory of the computer system as data structures and/or program instructions. The graphical program, e.g., these data structures and/or program instructions, may be compiled or interpreted to produce machine language that accomplishes the desired method or process as shown in the graphical program.

Input data to a graphical program may be received from any of various sources, such as from a device, unit under test, a process being measured or controlled, another computer program, a database, or from a file. Also, a user may input data to a graphical program or virtual instrument using a graphical user interface, e.g., a front panel.

A graphical program may optionally have a GUI associated with the graphical program. In this case, the plurality of interconnected blocks or nodes are often referred to as the block diagram portion of the graphical program.

Node—In the context of a graphical program, an element that may be included in a graphical program. The graphical program nodes (or simply nodes) in a graphical program may also be referred to as blocks. A node may have an associated icon that represents the node in the graphical program, as well as underlying code and/or data that implements functionality of the node. Exemplary nodes (or blocks) include function nodes, sub-program nodes, terminal nodes, structure nodes, etc. Nodes may be connected together in a graphical program by connection icons or wires.

Data Flow Program—A Software Program in which the program architecture is that of a directed graph specifying the flow of data through the program, and thus functions execute whenever the necessary input data are available. Data flow programs can be contrasted with procedural programs, which specify an execution flow of computations to be performed.

Graphical Data Flow Program (or Graphical Data Flow Diagram)—A Graphical Program which is also a Data Flow Program. A Graphical Data Flow Program comprises a plurality of interconnected nodes (blocks), wherein at least a subset of the connections among the nodes visually indicate that data produced by one node is used by another node. A LabVIEW VI is one example of a graphical data flow program. A Simulink block diagram is another example of a graphical data flow program.

Graphical User Interface—this term is intended to have the full breadth of its ordinary meaning The term “Graphical User Interface” is often abbreviated to “GUI”. A GUI may comprise only one or more input GUI elements, only one or more output GUI elements, or both input and output GUI elements.

The following provides examples of various aspects of GUIs. The following examples and discussion are not intended to limit the ordinary meaning of GUI, but rather provide examples of what the term “graphical user interface” encompasses:

A GUI may comprise a single window having one or more GUI Elements, or may comprise a plurality of individual GUI Elements (or individual windows each having one or more GUI Elements), wherein the individual GUI Elements or windows may optionally be tiled together.

A GUI may be associated with a graphical program. In this instance, various mechanisms may be used to connect GUI Elements in the GUI with nodes in the graphical program. For example, when Input Controls and Output Indicators are created in the GUI, corresponding nodes (e.g., terminals) may be automatically created in the graphical program or block diagram. Alternatively, the user can place terminal nodes in the block diagram which may cause the display of corresponding GUI Elements front panel objects in the GUI, either at edit time or later at run time. As another example, the GUI may comprise GUI Elements embedded in the block diagram portion of the graphical program.

Front Panel—A Graphical User Interface that includes input controls and output indicators, and which enables a user to interactively control or manipulate the input being provided to a program, and view output of the program, while the program is executing.

A front panel is a type of GUI. A front panel may be associated with a graphical program as described above.

In an instrumentation application, the front panel can be analogized to the front panel of an instrument. In an industrial automation application the front panel can be analogized to the MMI (Man Machine Interface) of a device. The user may adjust the controls on the front panel to affect the input and view the output on the respective indicators.

Graphical User Interface Element—an element of a graphical user interface, such as for providing input or displaying output. Exemplary graphical user interface elements comprise input controls and output indicators.

Input Control—a graphical user interface element for providing user input to a program. An input control displays the value input the by the user and is capable of being manipulated at the discretion of the user. Exemplary input controls comprise dials, knobs, sliders, input text boxes, etc.

Output Indicator—a graphical user interface element for displaying output from a program. Exemplary output indicators include charts, graphs, gauges, output text boxes, numeric displays, etc. An output indicator is sometimes referred to as an “output control”.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Measurement Device—includes instruments, data acquisition devices, smart sensors, and any of various types of devices that are configured to acquire and/or store data. A measurement device may also optionally be further configured to analyze or process the acquired or stored data. Examples of a measurement device include an instrument, such as a traditional stand-alone “box” instrument, a computer-based instrument (instrument on a card) or external instrument, a data acquisition card, a device external to a computer that operates similarly to a data acquisition card, a smart sensor, one or more DAQ or measurement cards or modules in a chassis, an image acquisition device, such as an image acquisition (or machine vision) card (also called a video capture board) or smart camera, a motion control device, a robot having machine vision, and other similar types of devices. Exemplary “stand-alone” instruments include oscilloscopes, multimeters, signal analyzers, arbitrary waveform generators, spectroscopes, and similar measurement, test, or automation instruments.

A measurement device may be further configured to perform control functions, e.g., in response to analysis of the acquired or stored data. For example, the measurement device may send a control signal to an external system, such as a motion control system or to a sensor, in response to particular data. A measurement device may also be configured to perform automation functions, i.e., may receive and analyze data, and issue automation control signals in response.

Subset—in a set having N elements, the term “subset” comprises any combination of one or more of the elements, up to and including the full set of N elements. For example, a subset of a plurality of icons may be any one icon of the plurality of the icons, any combination of one or more of the icons, or all of the icons in the plurality of icons. Thus, a subset of an entity may refer to any single element of the entity as well as any portion up to and including the entirety of the entity.

Model of Computation (or Computational Model)—a model for visually specifying or visually representing program code to a user. A “model of computation” may also be considered as a set of program semantics of a programming language. Examples of “models of computation” include various forms of graphical data flow, such as data driven data flow (e.g., LabVIEW), demand driven data flow, and statically-scheduled data flow (including, but not limited to, synchronous data flow, heterochronous data flow, cyclo-static data flow, parameterized synchronous data flow, and discrete time data flow); synchronous reactive; process network; state diagram; control flow diagram; simulation diagram models (continuous time simulation data flow); various forms of text-based code (such as Matlab and MathScript, C, C++, etc.); and/or physical simulation (including physical domains such as circuits, hydrodynamics, mechanics, device modeling, thermodynamics, etc.), among others. “Statically-scheduled data flow” is data flow in which the firing pattern (i.e. execution order) of nodes is data-independent and can, therefore, be determined before run-time, e.g. at compile time. A “process network” is a set of deterministic sequential processes communicating through FIFO channels. “Synchronous reactive” can refer to a program where operations are given a certain amount of time to react, and if this constraint holds, the rest of the system appears synchronous.

A program portion may be visually represented on a display in a first computational model, but may in fact be actually implemented in the computer using a different computational model that may be hidden from the user. For example, Matlab is a text-based scripting language that is implanted in the C programming language. As another example, MathScript is a text-based scripting language implemented in the LabVIEW graphical programming language. A program portion may be represented in a first model of computation to provide a more intuitive visual representation of the functionality of the program portion, e.g., to allow the user to more readily understand and/or edit the program portion.

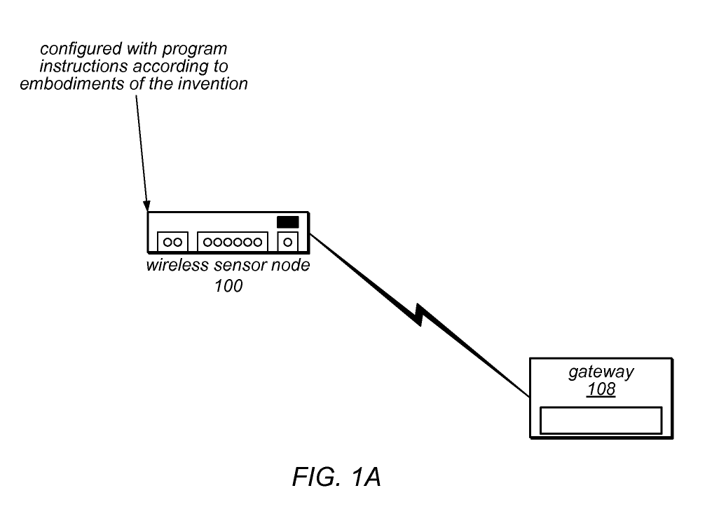

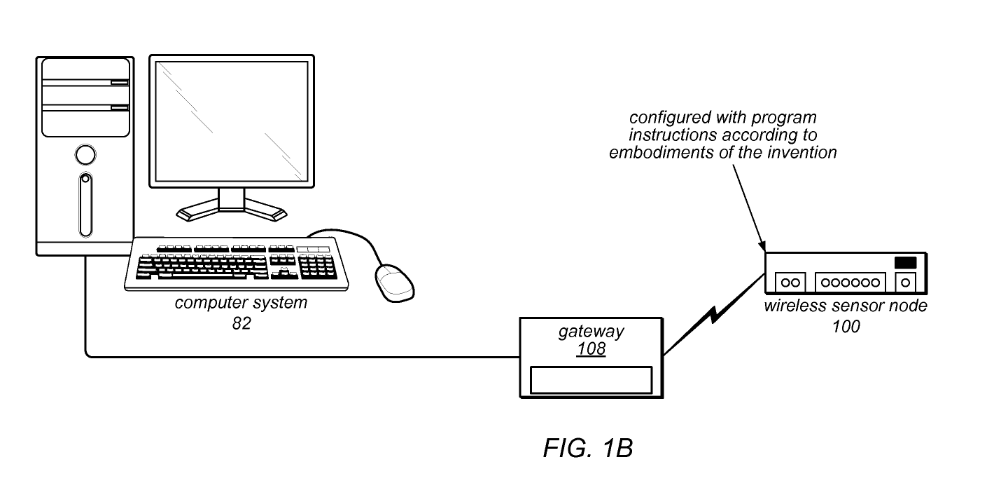

### FIGS. 1A and 1B—Exemplary Sensor Networks

FIGS. 1A and 1B illustrate exemplary wireless sensor networks, according to an embodiment. Embodiments of a method for transfer of time stamped multichannel data over a lossy mesh network by a wireless sensor node are described below.

As shown in FIG. 1A, the wireless sensor network may include at least one wireless sensor node 100, which may be communicatively coupled to a gateway device 108 via wireless transmission means, e.g., wireless Ethernet, Bluetooth™, or any other wireless connection. The wireless sensor node, which for brevity may be referred to herein as a “wireless node”, or simply “sensor node”, may include or be coupled to at least one sensor, and may be configured with program instructions implementing embodiments of the present invention. The wireless sensor node may be configured to receive sensor data from the at least one sensor, and transmit the sensor data to the gateway device 108 (which may be referred to herein as the “gateway”). The gateway device 108 may be configured to receive and store the transmitted data from the at least one wireless sensor node. In some embodiments, the gateway device 108 may subsequently transmit the data to a third entity, e.g., a host controller, as shown in FIG. 1B. In another embodiment, the gateway device 108 may be the host controller.

FIG. 1B illustrates an exemplary wireless sensor network that includes a host controller, according to an embodiment. As shown in FIG. 1B, in this embodiment, the wireless sensor node 100 may be coupled to the gateway device 108 via wireless transmission means, and the gateway device 108 may be coupled to host controller 82, i.e., a computer system, e.g., via wired or wireless means. In another embodiment, the gateway device 108 may be or include the host controller. As noted above, the gateway device 108 may be configured to receive and store the transmitted data from the at least one wireless sensor node. In some embodiments, the gateway device 108 may be further configured to process the received data. For example, in one embodiment, the gateway device may be configured to receive time stamped data from the wireless sensor node, and to sort or order, or otherwise organize the data as desired. In another embodiment, the gateway device may process the data in other ways, e.g., analyzing, conditioning, deriving further data from the received data, and so forth, as desired.

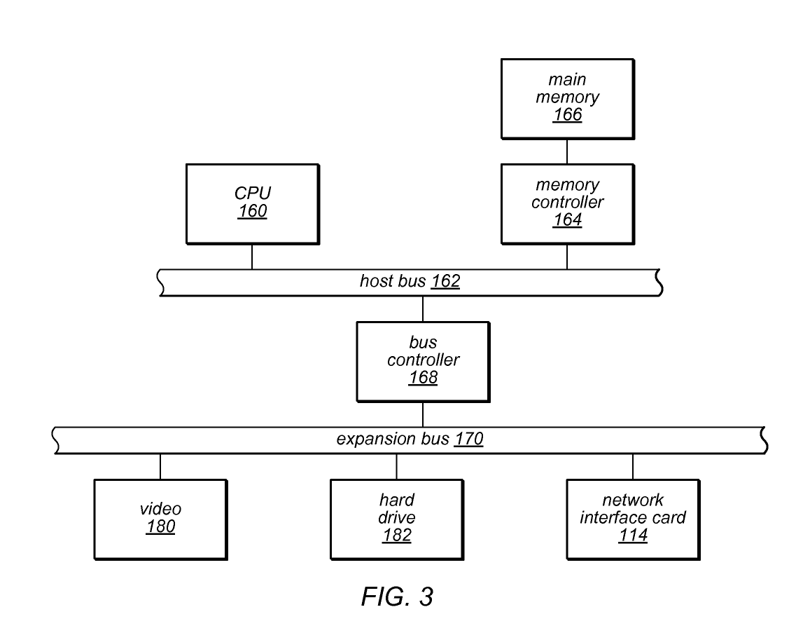

The host controller 82, i.e., computer system, may be any of various types of computer systems. Computer system 82 may include a processor, a memory medium, as well as other components as may typically be found in a computer system. The memory medium of the computer system may store a program development environment for creating programs. The computer system 82 is described in more detail below with reference to FIG. 3. As used herein, the term program is intended to include text-based or graphical instructions which are executable, compilable, and/or interpretable by a processor or programmable hardware element (such as a Field Programmable Gate Array (FPGA)) to perform a specified function or functions. Further details regarding operation of the wireless sensor node are provided below.

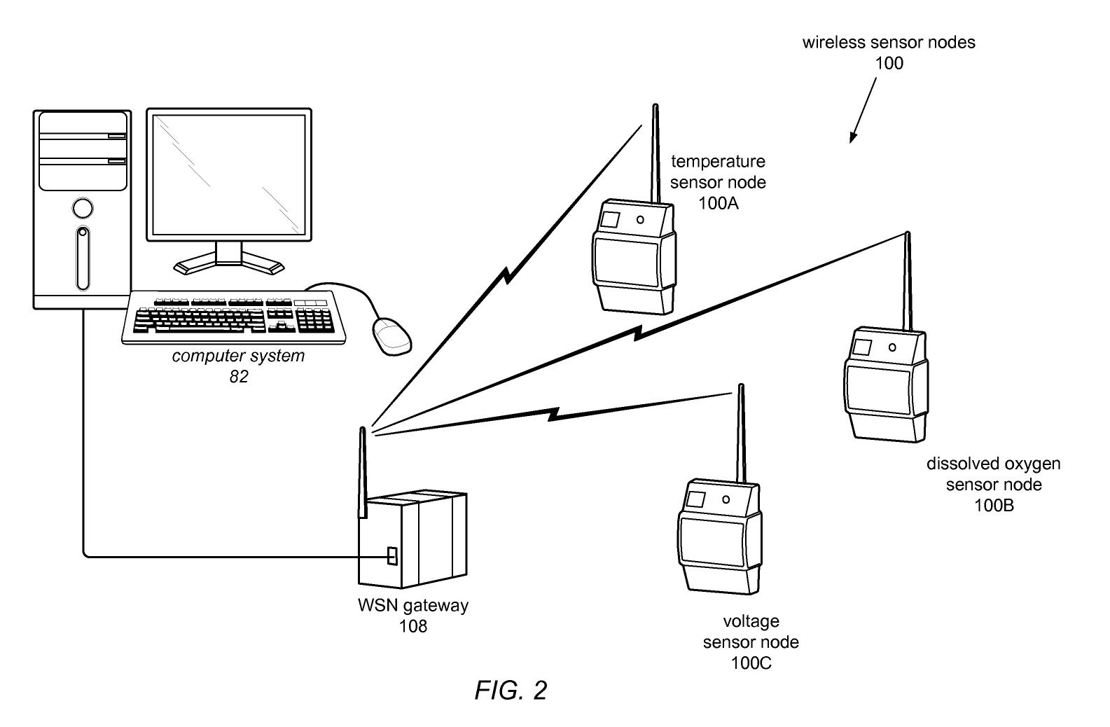

### FIG. 2—Exemplary Implementation of Wireless Sensor System

FIG. 2 illustrates an exemplary implementation of a wireless sensor system, e.g., a wireless sensor network (WSN), including a host computer, according to an embodiment of the present invention. More specifically, FIG. 2 illustrates an embodiment where a heterogeneous mix of wireless sensor nodes 100 is coupled to a wireless sensor network gateway 108, including a wireless sensor node configured to detect temperature 100A, a wireless sensor node configured to detect dissolved oxygen 100B, and a wireless sensor node configured to detect voltage 100C, although it should be noted that the particular types of sensors/sensor nodes shown are meant to be exemplary only, and are not intended to limit the types of sensors used to any particular type or form. For example, sensors contemplated include, but are not limited to, sensors for detecting forces such as strain, tension, gravity, electric or magnetic field strength; chemicals, e.g., toxins, biological hazards, drugs, hormones, pollutants, petrochemicals or hydrocarbons, e.g., natural gas, methane, oil, and so forth; or any other detectable phenomena. Additionally, while in some embodiments, the wireless sensor system may be implemented as a wireless sensor network, in other embodiments, the wireless sensor nodes may communicate point-to-point, or in accordance with other non-network topologies, as desired.

Further information regarding embodiments of the wireless sensor nodes are provided below.

### FIG. 3—Computer System Block Diagram

FIG. 3 is a block diagram for computer system 82, which may be referred to as a host controller, which may be configured to implement various embodiments of the present invention. More specifically, the computer system 82 may be configured to receive and store data from a wireless sensor system (e.g., network) gateway, e.g., gateway device 108, described above. In some embodiments, the computer system may be configured to program the gateway device 108 and/or the at least one wireless sensor node 100. For example, the computer system may be configured to download one or more programs onto the wireless sensor node and/or the gateway device, thereby configuring these devices to implement embodiments of the invention. The one or more programs may be of any of a variety of programs, including, for example, text-based programs, graphical programs, e.g., graphical developed under the LabVIEW graphical programming environment, provided by National Instruments Corporation, and/or hardware configuration programs for configuring programmable hardware elements, such as field programmable gate arrays (FPGAs). In some embodiments, the computer system 82 may configure the wireless sensor node(s) and/or the gateway device 108 by downloading configuration data to the device(s).

The computer system 82 may be any type of computer system, including a personal computer system, mainframe computer system, workstation, network appliance, Internet appliance, personal digital assistant (PDA), laptop computer, tablet computer, television system or other device. In general, the term “computer system” can be broadly defined to encompass any device having at least one processor that executes instructions from a memory medium. The computer may include at least one central processing unit or CPU 160 which is coupled to a processor or host bus 162. The CPU 160 may be any of various types, including an x86 processor, e.g., a Pentium class, a PowerPC processor, a CPU from the SPARC family of RISC processors, as well as others.

The computer system 82 may include a memory medium(s) 166 on which one or more computer programs or software components according to one embodiment of the present invention may be stored. For example, the memory medium may store a graphical program execution system, as well as one or more graphical programs, as described above. Also, the memory medium may store a graphical programming development environment application used to create and/or execute such graphical programs. The memory medium may also store operating system software, as well as other software for operation of the computer system.

The term “memory medium” is intended to include an installation medium, e.g., a CD-ROM, floppy disks 104, or tape device; a computer system memory or random access memory such as DRAM, SRAM, EDO RAM, Rambus RAM, etc.; or a non-volatile memory such as a magnetic media, e.g., a hard drive, or optical storage. The memory medium may comprise other types of memory as well, or combinations thereof. In addition, the memory medium may be located in a first computer in which the programs are executed, or may be located in a second different computer which connects to the first computer over a network, such as the Internet. In the latter instance, the second computer may provide program instructions to the first computer for execution.

As FIG. 3 shows, the memory medium 166 may be coupled to the host bus 162 by means of memory controller 164. The host bus 162 may be coupled to an expansion or input/output bus 170 by means of a bus controller 168 or bus bridge logic. The expansion bus 170 may be the PCI (Peripheral Component Interconnect) expansion bus, although other bus types can be used. The expansion bus 170 includes slots for various devices, such as a network interface card 114, a video display subsystem 180, and hard drive 1102 coupled to the expansion bus 170.

Note that in the present application, the term “graphical program” or “block diagram” is intended to include a program comprising graphical code, e.g., two or more interconnected nodes or icons, wherein the interconnected nodes or icons may visually indicate the functionality of the program. The nodes may be connected in one or more of a data flow, control flow, and/or execution flow format. The nodes may also be connected in a “signal flow” format, which is a subset of data flow. Thus the terms “graphical program” or “block diagram” are each intended to include a program comprising a plurality of interconnected nodes or icons which visually indicate the functionality of the program.

A graphical program may also comprise a user interface or front panel. The user interface portion may be contained in the block diagram or may be contained in one or more separate panels or windows. The user interface of a graphical program may include various graphical user interface elements or front panel objects, such as user interface controls and/or indicators, that represent or display the respective input and/or output that will be used by the graphical program or VI, and may include other icons which represent devices being controlled. The user interface or front panel may be comprised in a single window of user interface elements, or may comprise a plurality of individual windows each having one or more user interface elements, wherein the individual windows may optionally be tiled together. As another example, the user interface or front panel may comprise user interface or front panel objects, e.g., the GUI, embedded in the block diagram. The user interface of a graphical program may display only output, only input, or both input and output. Further, in some embodiments the user interface operates as a front panel, wherein the user can interactively control or manipulate the input being provided to the graphical program during program execution and can view resulting output.

Examples of graphical programming development environments that may be used to create graphical programs include LabVIEW, DasyLab, and DiaDem from National Instruments, VEE from Agilent, WiT from Coreco, Vision Program Manager from PPT Vision, SoftWIRE from Measurement Computing, Simulink from the MathWorks, Sanscript from Northwoods Software, Khoros from Khoral Research, SnapMaster from HEM Data, VisSim from Visual Solutions, ObjectBench by SES (Scientific and Engineering Software), and VisiDAQ from Advantech, among others. In the preferred embodiment, the system uses the LabVIEW graphical programming system available from National Instruments Corporation.

Graphical software programs which perform data acquisition, analysis and/or presentation, e.g., for measurement, instrumentation control, industrial automation, modeling, or simulation, such as in the applications shown in FIGS. 2A and 2B, may be referred to as virtual instruments.

### Exemplary Systems

Embodiments of the present invention may be involved with performing test and/or measurement functions; controlling and/or modeling instrumentation or industrial automation hardware; modeling and simulation functions, e.g., modeling or simulating a device or product being developed or tested, etc. Exemplary test applications where the graphical program may be used include hardware-in-the-loop testing and rapid control prototyping, among others. For example, the graphical programs developed using the techniques described herein may be used in any of such industrial applications.

However, it is noted that embodiments of the present invention can be used for a plethora of applications and is not limited to the above applications. In other words, applications discussed in the present description are exemplary only, and embodiments of the present invention may be used in any of various types of systems. Thus, embodiments of the system and method of the present invention is configured to be used in any of various types of applications, including the control of other types of devices such as multimedia devices, video devices, audio devices, telephony devices, Internet devices, etc., as well as general purpose software applications such as word processing, spreadsheets, network control, network monitoring, financial applications, games, etc.

It should be further noted that as used herein, the term “or” is intended to be inclusive, i.e., means “and/or”. Cases where “exclusive or” (i.e., “XOR”) is intended will be explicitly indicated.

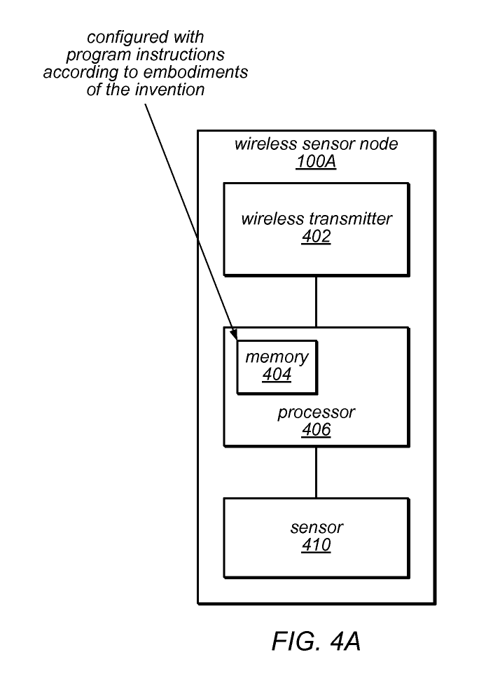

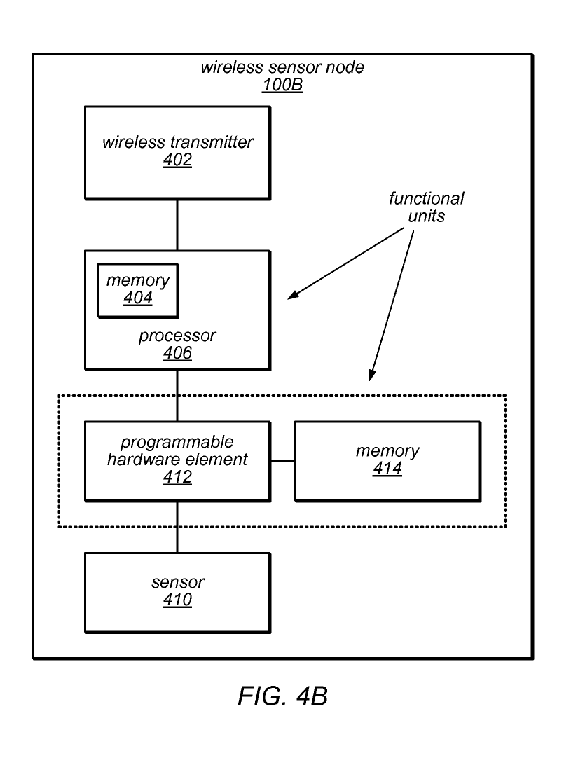

### FIGS. 4A and 4B—Exemplary Wireless Sensor Nodes

FIGS. 4A and 4B are block diagrams representing exemplary embodiments of the wireless sensor node disclosed herein.

FIG. 4A illustrates an exemplary wireless sensor node architecture, according to one embodiment. As shown, in this embodiment, the wireless sensor node 100A includes a wireless transmitter 402, e.g., a wireless network transmitter or transceiver, which may be configured to send (and in the case of a transceiver, to receive) information between the wireless sensor node and a gateway device, and in some embodiments, a host controller, e.g., over a wireless network, or via point-to-point transmission or other wireless media with non-networked topologies. As may be seen, the wireless transmitter 402 may be coupled to a processor 406 and memory 404, which may be referred to collectively as a type of functional unit, and which may be configured with program instructions implementing embodiments of the present invention. As used herein, the term “functional unit” may refer to a processor and memory or a programmable hardware element (possibly with memory). The term “functional unit” may include one or more processors and memories and/or one or more programmable hardware elements.

The memory and processor (e.g., functional unit) may be further coupled to at least one sensor 410. Note that while in this embodiment, the (at least one) sensor 410 is shown comprised inside the wireless sensor node, in other embodiments, the (at least one) sensor 410 may be external to the sensor node's enclosure, as is well known in the art. Moreover, in some embodiments, the wireless sensor node may include or be coupled to multiple sensors, possibly of different types.

FIG. 4B illustrates an exemplary wireless sensor node architecture, according to another embodiment. More specifically, in the embodiment of FIG. 4B, the wireless sensor node 100B includes the elements shown in the embodiment of FIG. 4A, i.e., a wireless transmitter 402, processor 406 and memory 404, and at least one sensor 410, and further includes a programmable hardware element 412 and memory 414, e.g., a field programmable gate array (FPGA), application specific integrated circuit (ASIC), or other type of programmable hardware or logic, coupled to (or comprising) the memory. Thus, in this embodiment, the wireless sensor node 100B includes two functional units, one comprising the processor 406 and memory 404, and the other comprising the programmable hardware element 412 and memory 414. It should be noted, however, that in other embodiments, the sensor node may include the programmable hardware element 412 and memory 414 but not the processor 406 and memory 404, or may include one or more of either or both types of functional unit, as desired. Note further that implementation of the functionality of the sensor node may be distributed across the functional units of the sensor node in any manner desired.

Additionally, while in the embodiments shown in FIGS. 4A and 4B, the functional unit is a processor with onboard memory, in other embodiments, the memory 404 may be external to (but communicatively coupled to) the processor 406 (or other type of functional unit), as desired.

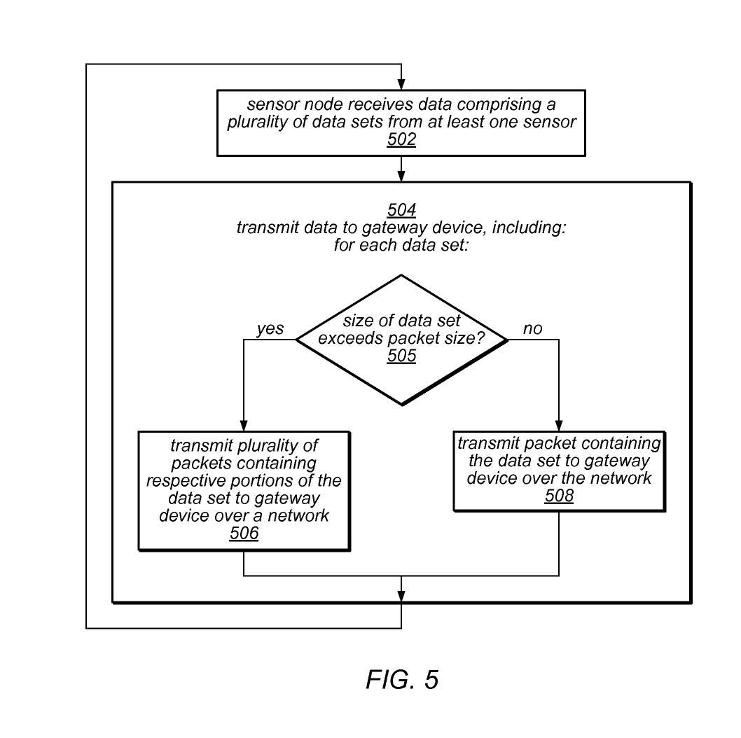

### FIG. 5—Flowchart of a Method for Reliable Transfer of Data Across a Lossy Mesh Network

FIG. 5 flowcharts a method for reliable transfer of data, e.g., time stamped multichannel data, across a lossy mesh network (or some other type of wireless medium, e.g., point-to-point wireless transmission), according to one embodiment. The method shown in FIG. 5 may be used in conjunction with any of the computer systems or devices shown in the above Figures, among other devices. In various embodiments, some of the method elements shown may be performed concurrently, in a different order than shown, or may be omitted. Additional method elements may also be performed as desired. As shown, this method may operate as follows.

First, in 502, the wireless sensor node may receive data from at least one sensor. In one embodiment, the received data may include a plurality of data sets. For example, in one exemplary application, the sensor node may be configured with a strain sensor for detecting strain, e.g., in a bridge or building infrastructure, where the strain sensor generates strain measurements, e.g., periodically, thereby generating multiple data sets over time. The strain measurements may include a waveform data type that is large enough to exceed the capacity of a single data packet. As indicated above, in some embodiments, the wireless sensor node may include multiple, possibly heterogeneous, sensors, e.g., strain, temperature, etc., and thus may generate data sets from measurements made by each sensor. Thus, the data may include a plurality of data sets, and may include data from multiple sensors, e.g., multi-channel data. Moreover, in some embodiments, the data may be time stamped. For example, each data set may include a time stamp indicating when the data were generated by the associated sensor, and/or when the data were received or acquired by the sensor node from the sensor.

In 504, the wireless sensor node 100 may transmit the received (measurement) data to a gateway device, e.g., gateway device 108. More specifically, the wireless sensor node may transmit multiple data sets to the gateway, processing each data set as described below.

Now, because there may be data sets that exceed the payload capacity of a packet, in order to transfer all of such a measurement data set from the sensor node to the gateway, the measurement data set may be subdivided into smaller sections and transferred using multiple data packets. Thus, as FIG. 5 indicates, for each data set, in 505, the sensor node may compare size of the data set with a specified packet size, i.e., with the size of a maximum payload for a packet.

If the size of the data set exceeds the specified packet size, then in 506, the sensor node may transmit a plurality of packets containing respective portions of the data set to a gateway device, e.g., over a network, point-to-point, etc.

However, if in 505, it is determined that the size of the data set does not exceed the specified packet size, the sensor node may transmit a packet containing the data set to the gateway device, e.g., over the network, as indicated in 508 of FIG. 5. Thus, the plurality of data sets may be packetized and transmitted to the gateway device 108 in a more efficient manner than prior art approaches.

As FIG. 5 further illustrates, in some embodiments, the method may iterate, where the sensor node receives further data, e.g., additional pluralities of data sets from the at least one sensor, and performs the above-described method elements with respect to each plurality of data sets.

### Further Embodiments

The following describes various exemplary embodiments of the above method, although it should be noted that the embodiments described are intended to be exemplary only, and are not intended to limit the invention to any particular form, functionality, or appearance.

In some embodiments, the wireless sensor node may determine that the wireless sensor node is (wirelessly) connected to the gateway device, e.g., over the network, point-to-point, etc., and may perform the above comparing and transmitting (505, 506, and 508) in response to detecting that the sensor node is connected to the gateway device. In a further embodiment, the wireless sensor node may wait for data from the at least one sensor, and may detect the data from the at least one sensor. The above comparing and transmitting (505, 506, and 508) may then be performed in response to the detected data from the at least one sensor.

Note that in some embodiments, a sensor node may queue up several measurement data samples in memory, which may be useful when radio communication is interrupted for an extended period of time. During this time the sensor node may continue to sample measurement data, and once the radio connection is reestablished the sensor node may send the measurement data history to the gateway, possibly using several data packets. Thus, in some embodiments, the method may further include (the wireless sensor node) determining if the wireless sensor node is connected to the gateway device, e.g., over the network, point-to-point, etc., and if the wireless sensor node is not connected to the gateway device, buffering at least a portion of the data received from the at least one sensor. The above comparing and transmitting (505, 506, and 508) may then be performed for data sets comprised in the buffered data upon connection to the gateway device.

Of course, in some cases, the buffer may become full. Thus, in some embodiments, when the buffer is full, the wireless sensor node may drop the oldest data in the buffer in response to adding new data to the buffer. Thus, the buffer may always hold the most recent data.

In one embodiment, the data received from the at least one sensor may include respective multiple data sets from two or more sensors, and the method may include (the wireless sensor node) timestamping each of the respective multiple data sets. Moreover, in one embodiment, the sensor node may aggregate the respective multiple data sets based on their respective timestamps, thereby generating aggregate data sets. The plurality of data sets may thus include the aggregate data sets. For example, in one embodiment, the respective multiple data sets may be aggregated based on specified timestamp ranges.

Transmitting the plurality of data sets may include transmitting at least a portion of the plurality of data sets in chronological (or reverse-chronological) order, e.g., based on either the individual timestamps or per the specified timestamp ranges.

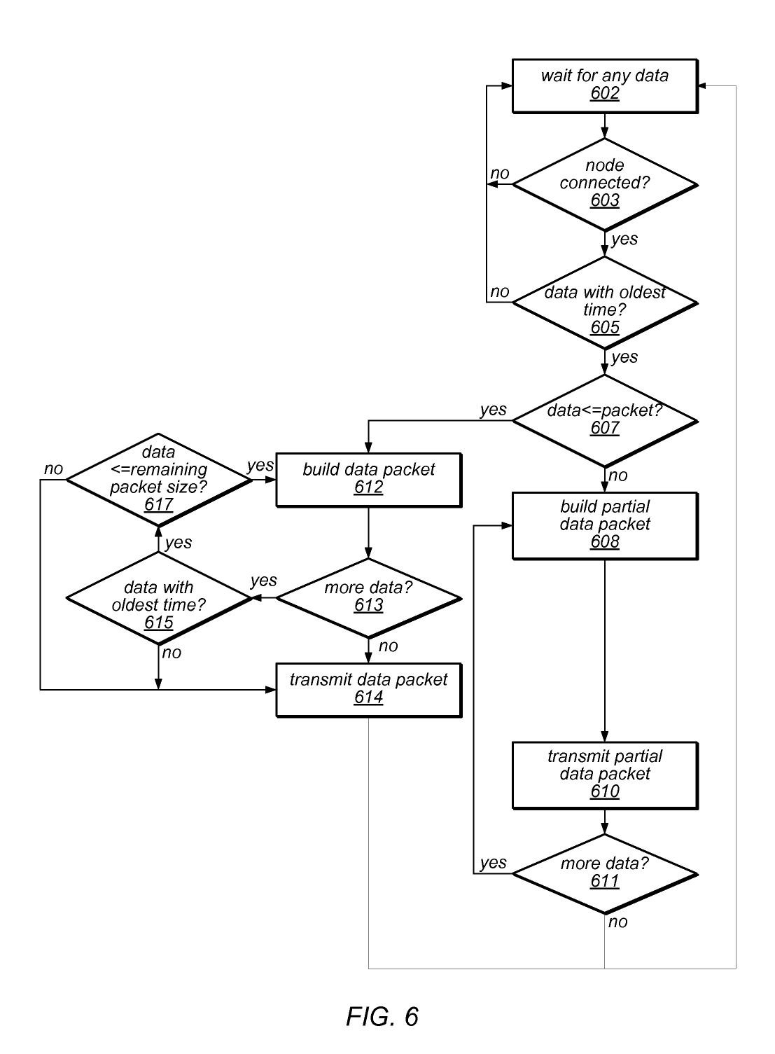

FIG. 6 flowcharts another exemplary embodiment of a method for reliable transfer of data, e.g., time stamped multichannel data, across a lossy mesh network (or other type of wireless medium, e.g., point-to-point wireless transmission, etc.). The method shown in FIG. 6 may be used in conjunction with any of the computer systems or devices shown in the above Figures, among other devices. In various embodiments, some of the method elements shown may be performed concurrently, in a different order than shown, or may be omitted. Additional method elements may also be performed as desired. As shown, this method may operate as follows.

First, in 602, the wireless sensor node may wait for data, e.g., a data set from the one or more sensors coupled to or contained in the sensor node. Once data have arrived, then in 603, a determination may be made as to whether the sensor node is connected, e.g., to the gateway device 108. If the sensor node is not connected, the method may return to 602, as indicated in FIG. 6.

If in 603, it is determined that the sensor node is connected, then in 605 the method may determine if data with the oldest time, e.g., with the oldest timestamp, has been found, and if not, may return to 602, as shown. For example, in 605, the sensor node may scan each data channel (data from each sensor) for data with the current oldest timestamp, and if no data sets are available for that timeslot (corresponding to the oldest timestamp value), the method may return to 602.

Alternatively, if the data with the oldest timestamp has been found, the method may proceed to 607, where a determination may be made as to whether the size of the data (set) is less than or equal to a specified packet size. In other words, if the sensor node finds that a data set (from one or more of the data channels) with the oldest time stamp is available, e.g., if multiple points of data with differing timestamps are available and one of the timestamps matches the oldest timestamp, then the method may proceed to 607, as indicated.

Table 1 provides an illustrative example of data sets from multiple channels with differing timestamps.

TABLE 1

| | Timestamp | Timestamp | Timestamp | Timestamp |
|---|---|---|---|---|
| | of data | of data | of data | of data |
| | set 0 | set 1 | set 2 | set 3 |
| Channel 0 | t0 | t0 + 1 | t0 + 2 | t0 + 3 |
| Channel 1 | t0 + 1 | t0 + 2 | t0 + 3 | t0 + 4 |
| Channel 2 | t0 | t0 + 1 | t0 + 2 | t0 + 3 |
| Channel 3 | t0 + 2 | t0 + 3 | t0 + 4 | t0 + 5 |

As may be seen, in this exemplary embodiment, the wireless sensor node has multiple channels (corresponding to respective sensors), e.g., four channels/sensors. Each channel has multiple data sets with unique timestamps.

The oldest timestamps for channels 0, 1, 2, 3 are t0, t0+1, t0, and t0+2 respectively. Note that in this example t0 is the oldest timestamp among all the data sets for all the channels. Thus, in 605, for channel 0 and channel 2, the method will return yes, while for channel 1 and channel 3, the method will return no.

If in 607, it is determined that the size of the data (set) exceeds that of the specified packet, then in 608, a data packet with only a portion (proper subset) of the data may be built. Such a packet (containing partial data) may be referred to as a partial data packet. The partial data packet (which preferably holds as much of the data as possible, but not all) may be transmitted (e.g., to the gateway device 108), as indicated in 610.

The method may then determine if there are more data left in the data set to be transmitted, as indicated in 611. If there are more data left in the data set to be transmitted, then the method may return to 608 to build another partial data packet, and may proceed as described above. If there are no more data left in the data set to be transmitted, then the method may return to 602, and may proceed as described above.

Now, returning to 607 of FIG. 6, if the size of the data (set) is determined to be smaller than or equal to the size of the specified packet, then in 612, a data packet may be build. In other words, if the entire data set will fit within a packet, then a packet may be built that contains the data set.

As mentioned above, in some embodiments, if there is still space left in the packet, then additional data may be added to the packet. Thus, as FIG. 6 also indicates, in 613 a determination may be made as to whether there are additional data to be transmitted, and if not, then in 614, the data packet may be transmitted (e.g., to the gateway device 108).

However, if in 613, it is determined that there are additional data to be transmitted, then the method may proceed to 615, where, similar to 605, the method may determine if data with the oldest time, e.g., with the oldest timestamp, has been found, and if not, may transmit the data packet in 614, after which the method may proceed to 602 and wait for more data. Note that since each data set may have an associated timestamp used for comparison with other data sets, in order to determine which data set to send, the sensor node may search through the data sets currently stored or buffered for the set with the oldest timestamp.

Alternatively, if the data with the oldest time or timestamp has been found, the method may proceed to 617, where, similar to 607, a determination may be made as to whether the size of the additional (and oldest) data (set) is less than or equal to the remaining space of the packet.

If in 617, it is determined that the size of the data (set) plus the additional data (set) does not exceed the remaining space of the packet, then the method may proceed to 612, where the data packet may be built, i.e., more specifically, where the (additional) data set is added to the packet, and then to 614, where the packet may be transmitted to the gateway device, and proceeding as described above. Note that since the original data (set) had already been placed in the packet, the additional data (set) is necessarily a different data set, e.g., is from a different channel (e.g., from a different sensor) and/or time from the data originally placed in the packet.

If in 617, it is determined that the size of the data (set) does exceed the size of the remaining space of the packet, then the method may proceed to 614, where the packet may be transmitted to the gateway device, continuing as described above.

Thus, in the embodiment of FIG. 6, if there are one or more data sets that meet time sequence criteria (e.g., oldest data) and that fit in a data packet that is already partially filled, these one or more data sets may be added to the packet and transmitted to the gateway device. It should also be noted that in some embodiments, when a partial data packet is built in 608, if the packet holds the last of the (large) data set, then the method may try to find further (small) data packets with the right timestamp to add to the packet prior to transmitting to the gateway device.

The method described above may then iterate, performing the above method elements with respect to further data (sets) received from the at least one sensor.

Referring again to Table 1, assuming the data set fits inside a packet, only channel 0 and 2 will transmit their data on this iteration. Once the packet for t0 is transmitted, the oldest timestamp in the entire set will be t0+1. Assuming the data fit inside a packet, channel 0, 1, and 2 will transmit data with timestamp t0+1. Once the packet for t0+1 is transmitted, the oldest timestamp in the entire set will be t0+2. Again, assuming these data fit inside a packet, data for channels 0, 1, 2, and 3 with timestamp t0+2 will be transmitted.

Thus, a sensor node may transfer large measurement data sets from the sensor node to the gateway using a plurality of smaller (than the data set) data packets. Note that in some embodiments, the sensor node may be responsible for maintaining state about the measurement data to be transmitted, e.g., time of acquisition or generation, etc. In some embodiments, the gateway may be responsible for sequencing the partial data packets and presenting the complete measurement data set to the user. More generally, since the sensor node sends packets containing respective portions of a single (large) time stamped data set, and/or packets containing one or more time stamped data sets, and since packet based communication does not guarantee receipt of packets in the order sent, the gateway may receive data in out of chronological order, and so may be configured to (re)order the received data, e.g., based on time stamps, or any other ordering information desired. For example, the received data may be ordered chronologically, or reverse-chronologically, as desired.

In one embodiment, if any portion of the transmitted data is lost, then the sensor node may resend the data. Additionally, in some embodiments, while sending a plurality of packets with data from a channel, no other channel's data may be transmitted.

Further regarding time stamps, as noted above, before sending the data packet, the method may look for one or more additional data sets, based on the data sets' timestamps, that can also fit inside the packet. In some embodiments, e.g., when strict timestamp handling is enabled, such as in data acquisition applications, the data timestamp may be required to be the same as that of the original data set already in the packet, while in other embodiments, e.g., when relaxed timestamp handling is enabled, e.g., for configuration data, etc., the data timestamp may simply be required to be within a configurable offset. Of course, any criteria for determining time stamp tolerance or strictness, may be used as desired. In other words, the size of the time stamp ranges used to select and/or aggregate data sets may be set as needed, possibly dynamically, e.g., based on the type of data, e.g., based on metadata for the data sets.

In one embodiment, the data in the data set may be from a single data channel, e.g., from a single sensor. As mentioned above, in addition to determining if the size of the data set does not exceed the specified packet size, the method may further determine if the size of the data set plus the size of one or more other data sets of the plurality of data sets does not exceed the specified packet size, and may transmit the packet containing the data set and the one or more other data sets to the gateway device over the network. In some embodiments, the one or more other data sets may not be constrained to be from the single data channel. In other words, in some embodiments, data sets from different channels (e.g., sensors) may be aggregated together based on their time stamps.

As also mentioned above, in some embodiments, the wireless sensor node may be configured to execute a graphical program. For example, the user may create or acquire a graphical program, e.g., specifying or implementing firmware functionality, for the sensor node on a host computer, e.g., computer 82. For example, the user may develop the graphical program under the LabVIEW graphical programming development environment, which may compile a binary firmware image from the graphical program. The binary firmware image may then be deployed to the sensor node, e.g., via the gateway device 108. Once the sensor node firmware image has been deployed, the sensor node may reset and start executing the graphical program.

It should be noted that the present invention is not intended to be limited to any particular form, function, or appearance, and may be implemented in any manner desired. For example, some embodiments may be implemented via programmable hardware elements, e.g., FPGAs, and so forth, as desired.

Thus, various embodiments of the techniques disclosed herein may provide for reliable transfer of time stamped multichannel data across a lossy mesh network.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A wireless sensor node, comprising:
at least one sensor;
a functional unit, coupled to the sensor;
a wireless transmitter coupled to the functional unit;
wherein the functional unit is configured to:
receive data from the at least one sensor, wherein the data comprise a plurality of data sets;
transmit the plurality of data sets to a gateway device over a wireless medium via the wireless transmitter, comprising:
for each data set:
compare size of the data set with a specified packet size;
a) if the size of the data set exceeds the specified packet size:
transmit a plurality of packets containing respective portions of the data set to a gateway device over the wireless medium; and
b) if the size of the data set does not exceed the specified packet size:
transmit a packet containing the data set to the gateway device over the wireless medium.

2. The wireless sensor node of claim 1, wherein the functional unit is further configured to:
determine if the wireless sensor node is connected to the gateway device over the wireless medium; and
if the wireless sensor node is not connected to the gateway device,
buffer at least a portion of the data received from the at least one sensor;
perform said comparing and said a) or b) for data sets comprised in the buffered data upon connection to the gateway device over the wireless medium.

3. The wireless sensor node of claim 2, wherein the functional unit is further configured to:
when the buffer is full, drop oldest data in the buffer in response to adding new data to the buffer.

4. The wireless sensor node of claim 1, wherein to receive data from at least one sensor, the functional unit is configured to receive respective multiple data sets from two or more sensors, wherein the functional unit is further configured to:
timestamp each of the respective multiple data sets; and
aggregate the respective multiple data sets based on their respective timestamps, thereby generating aggregate data sets;
wherein the plurality of data sets comprise the aggregate data sets.

5. The wireless sensor node of claim 4, wherein to aggregate the respective multiple data sets based on their respective timestamps, the functional unit is configured to:
aggregate the respective multiple data sets based on specified timestamp ranges.

6. The wireless sensor node of claim 4, wherein to transmit the plurality of data sets, the functional unit is configured to:
transmit at least a portion of the plurality of data sets in chronological or reverse-chronological order.

7. The wireless sensor node of claim 1,
wherein the data in the data set is from a single data channel; and
wherein to perform b), the functional unit is further configured to:
if the size of the data set does not exceed the specified packet size, and if the size of the data set plus the size of one or more other data sets of the plurality of data sets does not exceed the specified packet size,
transmit the packet containing the data set and the one or more other data sets to the gateway device over the wireless medium, wherein the one or more other data sets are not constrained to be from the single data channel.

8. The wireless sensor node of claim 1, wherein the functional unit is further configured to:
wait for data from the at least one sensor; and
detect the data from the at least one sensor;
wherein said comparing and said a) or b) are performed in response to the detected data from the at least one sensor.

9. The wireless sensor node of claim 1, wherein the functional unit is further configured to:
determine that the wireless sensor node is connected to the gateway device over the wireless medium;
wherein said comparing and said a) or b) are performed in response to said determining.

10. The wireless sensor node of claim 1, wherein the functional unit comprises a processor and memory medium.

11. The wireless sensor node of claim 1, wherein the functional unit comprises a programmable hardware element.

12. A method, comprising:
a wireless sensor node performing:
receiving data from at least one sensor, wherein the data comprise a plurality of data sets;
for each data set:
comparing size of the data set with a specified packet size;
a) if the size of the data set exceeds the specified packet size:
transmitting a plurality of packets containing respective portions of the data set to a gateway device over a wireless medium; and
b) if the size of the data set does not exceed the specified packet size:
transmitting a packet containing the data set to the gateway device over the wireless medium.

13. The method of claim 12, further comprising:
the wireless sensor node performing:
determining if the wireless sensor node is connected to the gateway device over the wireless medium; and
if the wireless sensor node is not connected to the gateway device,
buffering at least a portion of the data received from the at least one sensor; and
performing said comparing and said a) or b) for data sets comprised in the buffered data upon connection to the gateway device over the wireless medium.

14. The method of claim 12, further comprising:
the wireless sensor node performing:
when the buffer is full, dropping oldest data in the buffer in response to adding new data to the buffer.

15. The method of claim 12, wherein said receiving data from at least one sensor comprises receiving respective multiple data sets from two or more sensors, the method further comprising:
the wireless sensor node performing:
timestamping each of the respective multiple data sets;
aggregating the respective multiple data sets based on their respective timestamps, thereby generating aggregate data sets;
wherein the plurality of data sets comprise the aggregate data sets.

16. The method of claim 15, wherein said aggregating the respective multiple data sets based on their respective timestamps comprises:
aggregating the respective multiple data sets based on specified timestamp ranges.

17. The method of claim 16, wherein said transmitting the plurality of data sets comprises:
transmitting at least a portion of the plurality of data sets in chronological or reverse-chronological order.

18. The method of claim 12,
wherein the data in the data set is from a single data channel; and
wherein b) further comprises:
if the size of the data set does not exceed the specified packet size, and if the size of the data set plus the size of one or more other data sets of the plurality of data sets does not exceed the specified packet size,
transmitting the packet containing the data set and the one or more other data sets to the gateway device over the wireless medium, wherein the one or more other data sets are not constrained to be from the single data channel.

19. The method of claim 12, further comprising:
the wireless sensor node performing:
waiting for data from the at least one sensor; and
detecting the data from the at least one sensor;
wherein said comparing and said a) or b) are performed in response to the detected data from the at least one sensor.

20. The method of claim 12, further comprising:
the wireless sensor node performing:
determining that the wireless sensor node is connected to the gateway device over the wireless medium;
wherein said comparing and said a) or b) are performed in response to said determining.
